(19) United States
(12) Patent Application Publication
(10) Pub. No.: US 2025/0212135 A1
(43) Pub. Date: Jun. 26, 2025

(54) METHODS AND APPARATUSES OF PHYSICAL SIDELINK FEEDBACK CHANNEL (PSFCH) TRANSMISSION

(71) Applicant: Lenovo (Beijing) Limited, Beijing (CN)

(72) Inventors: Zhennian Sun, Beijing (CN); Xiaodong Yu, Beijing (CN); Haipeng Lei, Beijing (CN); Xin Guo, Beijing (CN)

(73) Assignee: Lenovo (Beijing) Limited, Beijing (CN)

(21) Appl. No.: 18/842,635

(22) PCT Filed: Mar. 3, 2022
(86) PCT No.: PCT/CN2022/079072

§ 371 Date: Aug. 29, 2024

(51) Int. Cl. H04W 52/34; H04W 52/36; H04W 52/38

(52) U.S. Cl. CPC H04W 52/346; H04W 52/367; H04W 52/383

(57) ABSTRACT

Embodiments of the present disclosure relate to methods and apparatuses for physical sidelink feedback channel (PSFCH) transmission. According to an embodiment of the present disclosure, a user equipment (UE) can include: a processor configured to: select one or more PSFCHs from a set of PSFCHs on a set of carriers overlapping in time domain, based on configuration information indicating a capability of simultaneous PSFCH transmissions of the UE and a maximum transmitting power for the UE; and a transceiver coupled to the processor and configured to: transmit the one or more PSFCHs.

### TECHNICAL FIELD

Embodiments of the present application are related to wireless communication technology, and more particularly, related to methods and apparatuses of physical sidelink feedback channel (PSFCH) transmission, e.g., in sidelink carrier aggregation (CA) operation.

### BACKGROUND

Sidelink (SL) is a long-term evolution (LTE) feature introduced in 3rd generation partnership project (3GPP) Release 12, and enables a direct communication between proximal user equipments (UEs), in which data does not need to go through a base station (BS) or a core network. A sidelink communication system has been introduced into 3GPP 5G wireless communication technology, in which a direct link between two UEs is called a sidelink.

In sidelink CA operation, the PSFCHs may be transmitted on multiple carriers. However, due to restrictions on UE's capability of simultaneous PSFCH transmissions and maximum transmitting power, not all of the PSFCHs can be transmitted simultaneously. Given this, the UE needs to select a part of the PSFCHs for actual transmission, which has not been solved yet.

### SUMMARY OF THE APPLICATION

Embodiments of the present application at least provide a technical solution for PSFCH transmission in sidelink CA operation.

According to some embodiments of the present application, a UE may include: a processor configured to: select one or more PSFCHs from a set of PSFCHs on a set of carriers overlapping in time domain, based on configuration information indicating a capability of simultaneous PSFCH transmissions of the UE and a maximum transmitting power for the UE; and a transceiver coupled to the processor and configured to: transmit the one or more PSFCHs.

In some embodiments of the present application, the capability of simultaneous PSFCH transmissions of the UE is a maximum number of simultaneous PSFCH transmissions for the UE on all carriers and the maximum transmitting power for the UE is a maximum transmitting power for the UE on all carriers.

In some embodiments of the present application, selecting the one or more PSFCHs from the set of PSFCHs may include: selecting the one or more PSFCHs from the set of PSFCHs according to an descending order of PSFCH priority, wherein a number of the one or more PSFCHs is less than or equal to the maximum number of simultaneous PSFCH transmissions for the UE on all carriers.

In some embodiments of the present application, a transmitting power for each PSFCH of the one or more PSFCHs is the same and a total transmitting power for the one or more PSFCHs is less than or equal to the maximum transmitting power for the UE on all carriers.

In some embodiments of the present application, selecting the one or more PSFCHs from the set of PSFCHs may include: determining whether a number of currently selected PSFCHs is smaller than the maximum number of simultaneous PSFCH transmissions for the UE on all carriers, or determining whether a number of currently selected PSFCHs plus one is smaller than or equal to the maximum number of simultaneous PSFCH transmissions of the UE on all carriers; and determining whether to select a PSFCH on a carrier as one of the one or more PSFCHs in response to that the number of currently selected PSFCHs is smaller than the maximum number of simultaneous PSFCH transmissions for the UE on all carriers or the number of currently selected PSFCHs plus one is smaller than or equal to the maximum number of simultaneous PSFCH transmissions for the UE on all carriers.

In some embodiments of the present application, the PSFCH on the carrier is determined from the set of PSFCHs according to an descending order of PSFCH priority; and determining whether to select the PSFCH on the carrier as one of the one or more PSFCHs may include: in the case that the carrier is a dedicated carrier, selecting the PSFCH; in the case that the carrier is a shared carrier, determining whether a total transmitting power of all currently selected PSFCHs and the PSFCH is less than or equal to the maximum transmitting power of the UE on all carriers; and selecting the PSFCH in response to the total transmitting power is less than or equal to the maximum transmitting power for the UE on all carriers.

In some embodiments of the present application, the capability of simultaneous PSFCH transmissions of the UE is a maximum number of simultaneous PSFCH transmissions for the UE on each carrier and the maximum transmitting power of the UE is a maximum transmitting power for the UE on all carriers.

In some embodiments of the present application, selecting the one or more PSFCHs from the set of PSFCHs may include: for each carrier, selecting at least one PSFCH from a sub-set of PSFCHs on a corresponding carrier according to an descending order of PSFCH priority, wherein a number of the at least one PSFCH is less than or equal to the maximum number of simultaneous PSFCH transmissions for the UE on the corresponding carrier.

In some embodiments of the present application, selecting the one or more PSFCHs from the set of PSFCHs may include: determining whether a number of currently selected PSFCHs is smaller than a determined number of the one or more PSFCHs; or determining whether a number of currently selected PSFCHs plus one is smaller than or equal to the determined number of the one or more PSFCHs; and determining whether to select a PSFCH on a carrier as one of the one or more PSFCHs in response to that the number of currently selected PSFCHs is smaller than the determined number of the one or more PSFCHs or the number of currently selected PSFCHs plus one is smaller than or equal to the determined number of the one or more PSFCHs.

In some embodiments of the present application, the PSFCH on the carrier is determined from the set of PSFCHs according to an descending order of PSFCH priority, and determining whether to select the PSFCH on the carrier as one of the one or more PSFCHs may include: determining whether a number of currently selected PSFCHs on the carrier is smaller than the maximum number of simultaneous PSFCH transmissions for the UE on the carrier; or determining whether a number of currently selected PSFCHs plus one is smaller than or equal to the maximum number of simultaneous PSFCH transmissions for the UE on the carrier; and selecting the PFCH on the carrier as one of the one or more PSFCHs in response to that the number of currently selected PSFCHs on the carrier is smaller than the maximum number of simultaneous PSFCH transmissions for the UE on the carriers or the number of currently selected PSFCHs on the carrier plus one is smaller than or equal to the maximum number of simultaneous PSFCH transmissions for the UE on the carrier.

In some embodiments of the present application, a transmitting power for each PSFCH of the one or more PSFCHs is the same and a total transmitting power for the one or more PSFCHs is less than or equal to the maximum transmitting power for simultaneous PSFCH transmissions of the UE.

In some embodiments of the present application, selecting the one or more PSFCHs from the set of PSFCHs may include: determining whether to select a PSFCH on a carrier as one of the one or more PSFCHs, wherein the PSFCH on the carrier is determined from the set of PSFCHs according to an descending order of PSFCH priority, and determining whether to select a PSFCH on the carrier as one of the one or more PSFCHs may include: determining whether a number of currently selected PSFCHs on the carrier is smaller than the maximum number of simultaneous PSFCH transmissions for the UE on the carrier; or determining whether a number of currently selected PSFCHs plus one is smaller than or equal to the maximum number of simultaneous PSFCH transmissions for the UE on the carrier; and in response to that the number of currently selected PSFCHs on the carrier is smaller than the maximum number of simultaneous PSFCH transmissions for the UE on the carriers or the number of currently selected PSFCHs on the carrier plus one is smaller than or equal to the maximum number of simultaneous PSFCH transmissions for the UE on the carrier: in the case of the carrier being a dedicated carrier, selecting the PSFCH on the carrier; in the case of the carrier being a shared carrier, determining whether a total transmitting power of all currently selected PSFCHs and the PSFCH on the carrier is less than or equal to the maximum transmitting power for the UE on all carriers; and selecting the PSFCH on the carrier in response to the total transmitting power is less than or equal to the maximum transmitting power for the UE on all carriers.

In some embodiments of the present application, the processor is further configured to: in the case that all the one or more PSFCHs are on dedicated carriers, determine that a transmitting power for each PSFCH of the one or more PSFCHs is the same and a total transmitting power for the one or more PSFCHs are less than or equal to the maximum transmitting power for the UE on all carriers; and in the case that the one or more PSFCHs include PSFCH(s) on carrier(s) shared with a Uu interface, determine that a transmitting power for each PSFCH of the one or more PSFCHs is the same and based on a downlink pathloss of the Uu interface.

In some embodiments of the present application, the capability of simultaneous PSFCH transmissions of the UE is a maximum number of simultaneous PSFCH transmissions for the UE on all the carriers and the maximum transmitting power for the UE is a maximum transmitting power for the UE on each carrier.

In some embodiments of the present application, a number of the set of carriers is larger than the maximum number of simultaneous PSFCH transmissions for the UE on all carriers, and selecting the one or more PSFCHs from the set of PSFCHs may include: selecting the one or more of PSFCHs with a number as the same as the maximum number of simultaneous PSFCH transmissions for the UE on all carriers in an descending order of highest PSFCH priority on each carrier.

In some embodiments of the present application, a transmitting power for each PSFCH on a corresponding carrier of the one or more PSFCHs is less than or equal to the maximum transmitting power for the UE on the corresponding carrier.

In some embodiments of the present application, a number of the set of carriers is smaller or equal to the maximum number of simultaneous PSFCH transmissions for the UE on all carriers, and selecting the one or more PSFCHs from the set of PSFCHs may include: for each carrier of the set of carriers, selecting a PSFCH of the set of PSFCHs with a highest priority on a corresponding carrier as a part of the one or more PSFCHs; and selecting the other part of the one or more PSFCHs from remaining PSFCHs of the set of PSFCHs in an descending order of PSFCH priority until a determined number of the one or more PSFCHs is satisfied, wherein the determined number of the one or more PSFCHs is less than or equal to the maximum number.

In some embodiments of the present application, a transmitting power for each PSFCH of the one or more PSFCHs on a corresponding carrier is the same and a total transmitting power for PSFCH(s) on the corresponding carrier is less than or equal to the maximum transmitting power for the UE on the corresponding carrier.

In some embodiments of the present application, wherein a number the set of carriers is smaller or equal to the maximum number of simultaneous PSFCH transmissions for the UE on all carriers, and selecting the one or more PSFCHs from the set of PSFCHs may include: for each carrier of the set of carriers, selecting a PSFCH of the set of PSFCHs with a highest priority on the corresponding carrier as a part of the one or more PSFCHs; and determining whether to select a PSFCH on a carrier from remaining PSFCHs of the set of PSFCHs in an descending order of PSFCH priority as the other part of the one or more PSFCHs in response to a number of currently selected PSFCHs is less than the maximum number or a number of currently selected PSFCHs plus one is less than or equal to the maximum number.

In some embodiments of the present application, determining whether to select the PSFCH on the carrier from the remaining PSFCHs of the set of PSFCHs may include: in the case that the carrier is a dedicated carrier, selecting the PSFCH on the carrier as one of the one or more PSFCHs; and in the case that the carrier is shared with a Uu interface, determining whether a transmitting power of all currently selected PSFCHs and the PSFCH on the carrier less than or equal to the maximum transmitting power on the carrier; and selecting the PSFCH on the carrier as one of the one or more PSFCHs in the case that the transmitting power is less than or equal to the maximum transmitting power on the carrier.

In some embodiments of the present application, a transmitting power for each PSFCH of the one or more PSFCHs on a dedicated carrier is the maximum transmitting power for the UE on the dedicated carrier; and a transmitting power for each PSFCH of the one or more PSFCHs on a shared carrier with a Uu interface is min (P_{CMAX,f}, P_{PSFCH,one}), wherein P_{CMAX,f} is the maximum transmitting power for performing simultaneous PSFCH transmissions on the carrier, and P_{PSFCH,one} is a transmitting power determined based on a downlink pathloss of the Uu interface.

In some embodiments of the present application, the capability of simultaneous PSFCH transmissions of the UE is a maximum number of simultaneous PSFCH transmissions for the UE on each carrier and the maximum transmitting power for the UE is a maximum transmitting power for the UE on each carrier.

In some embodiments of the present application, the configuration information indicates a set of maximum transmitting powers for the UE on all carriers, and each maximum transmitting power of the set of maximum transmitting powers is associated with at least one of a priority or a constant bit rate (CBR) range; and the processor is further configured to determine a maximum transmitting power from the set of maximum transmitting powers based on at least one of: a priority of a PSFCH in the set of PSFCHs or a measured CBR.

In some embodiments of the present application, the configuration information indicates a set of maximum transmitting powers for the UE on each carrier, and each maximum transmitting power of the set of maximum transmitting powers is associated with at least one of a priority or a CBR range; and the processor is further configured to select a maximum transmitting power for each carrier from the set of transmitting powers associated with the carrier based on at least one of: a priority of a PSFCH on a corresponding carrier or a measured CBR.

According to some other embodiments of the present application, a method performed by a UE may include: selecting one or more physical sidelink feedback channel (PSFCHs) from a set of PSFCHs overlapping in the time domain on a set of carriers, based on configuration information indicating a capability of simultaneous PSFCH transmissions and a maximum transmitting power for simultaneous PSFCH transmissions; and transmitting the one or more PSFCHs.

In some embodiments of the present application, the capability of simultaneous PSFCH transmissions of the UE is a maximum number of simultaneous PSFCH transmissions for the UE on all carriers and the maximum transmitting power for the UE is a maximum transmitting power for the UE on all carriers.

In some embodiments of the present application, selecting the one or more PSFCHs from the set of PSFCHs may include: selecting the one or more PSFCHs from the set of PSFCHs according to an descending order of PSFCH priority, wherein a number of the one or more PSFCHs is less than or equal to the maximum number of simultaneous PSFCH transmissions for the UE on all carriers.

In some embodiments of the present application, a transmitting power for each PSFCH of the one or more PSFCHs is the same and a total transmitting power for the one or more PSFCHs is less than or equal to the maximum transmitting power for the UE on all carriers.

In some embodiments of the present application, selecting the one or more PSFCHs from the set of PSFCHs may include: determining whether a number of currently selected PSFCHs is smaller than the maximum number of simultaneous PSFCH transmissions for the UE on all carriers, or determining whether a number of currently selected PSFCHs plus one is smaller than or equal to the maximum number of simultaneous PSFCH transmissions of the UE on all carriers; and determining whether to select a PSFCH on a carrier as one of the one or more PSFCHs in response to that the number of currently selected PSFCHs is smaller than the maximum number of simultaneous PSFCH transmissions for the UE on all carriers or the number of currently selected PSFCHs plus one is smaller than or equal to the maximum number of simultaneous PSFCH transmissions for the UE on all carriers.

In some embodiments of the present application, the PSFCH on the carrier is determined from the set of PSFCHs according to an descending order of PSFCH priority; and determining whether to select the PSFCH on the carrier as one of the one or more PSFCHs may include: in the case that the carrier is a dedicated carrier, selecting the PSFCH; in the case that the carrier is a shared carrier, determining whether a total transmitting power of all currently selected PSFCHs and the PSFCH is less than or equal to the maximum transmitting power of the UE on all carriers; and selecting the PSFCH in response to the total transmitting power is less than or equal to the maximum transmitting power for the UE on all carriers.

In some embodiments of the present application, the capability of simultaneous PSFCH transmissions of the UE is a maximum number of simultaneous PSFCH transmissions for the UE on each carrier and the maximum transmitting power of the UE is a maximum transmitting power for the UE on all carriers.

In some embodiments of the present application, selecting the one or more PSFCHs from the set of PSFCHs may include: for each carrier, selecting at least one PSFCH from a sub-set of PSFCHs on a corresponding carrier according to an descending order of PSFCH priority, wherein a number of the at least one PSFCH is less than or equal to the maximum number of simultaneous PSFCH transmissions for the UE on the corresponding carrier.

In some embodiments of the present application, selecting the one or more PSFCHs from the set of PSFCHs may include: determining whether a number of currently selected PSFCHs is smaller than a determined number of the one or more PSFCHs; or determining whether a number of currently selected PSFCHs plus one is smaller than or equal to the determined number of the one or more PSFCHs; and determining whether to select a PSFCH on a carrier as one of the one or more PSFCHs in response to that the number of currently selected PSFCHs is smaller than the determined number of the one or more PSFCHs or the number of currently selected PSFCHs plus one is smaller than or equal to the determined number of the one or more PSFCHs.

In some embodiments of the present application, the PSFCH on the carrier is determined from the set of PSFCHs according to an descending order of PSFCH priority, and determining whether to select the PSFCH on the carrier as one of the one or more PSFCHs may include: determining whether a number of currently selected PSFCHs on the carrier is smaller than the maximum number of simultaneous PSFCH transmissions for the UE on the carrier; or determining whether a number of currently selected PSFCHs plus one is smaller than or equal to the maximum number of simultaneous PSFCH transmissions for the UE on the carrier; and selecting the PFCH on the carrier as one of the one or more PSFCHs in response to that the number of currently selected PSFCHs on the carrier is smaller than the maximum number of simultaneous PSFCH transmissions for the UE on the carriers or the number of currently selected PSFCHs on the carrier plus one is smaller than or equal to the maximum number of simultaneous PSFCH transmissions for the UE on the carrier.

In some embodiments of the present application, a transmitting power for each PSFCH of the one or more PSFCHs is the same and a total transmitting power for the one or more PSFCHs is less than or equal to the maximum transmitting power for simultaneous PSFCH transmissions of the UE.

In some embodiments of the present application, selecting the one or more PSFCHs from the set of PSFCHs may include: determining whether to select a PSFCH on a carrier as one of the one or more PSFCHs, wherein the PSFCH on the carrier is determined from the set of PSFCHs according to an descending order of PSFCH priority, and determining whether to select a PSFCH on the carrier as one of the one or more PSFCHs may include: determining whether a number of currently selected PSFCHs on the carrier is smaller than the maximum number of simultaneous PSFCH transmissions for the UE on the carrier; or determining whether a number of currently selected PSFCHs plus one is smaller than or equal to the maximum number of simultaneous PSFCH transmissions for the UE on the carrier; and in response to that the number of currently selected PSFCHs on the carrier is smaller than the maximum number of simultaneous PSFCH transmissions for the UE on the carriers or the number of currently selected PSFCHs on the carrier plus one is smaller than or equal to the maximum number of simultaneous PSFCH transmissions for the UE on the carrier: in the case of the carrier being a dedicated carrier, selecting the PSFCH on the carrier; in the case of the carrier being a shared carrier, determining whether a total transmitting power of all currently selected PSFCHs and the PSFCH on the carrier is less than or equal to the maximum transmitting power for the UE on all carriers; and selecting the PSFCH on the carrier in response to the total transmitting power is less than or equal to the maximum transmitting power for the UE on all carriers.

In some embodiments of the present application, the method may further include: in the case that all the one or more PSFCHs are on dedicated carriers, a transmitting power for each PSFCH of the one or more PSFCHs is the same and a total transmitting power for the one or more PSFCHs are less than or equal to the maximum transmitting power for the UE on all carriers; and in the case that the one or more PSFCHs include PSFCH(s) on carrier(s) shared with a Uu interface, a transmitting power for each PSFCH of the one or more PSFCHs is the same and based on a downlink pathloss of the Uu interface.

In some embodiments of the present application, the capability of simultaneous PSFCH transmissions of the UE is a maximum number of simultaneous PSFCH transmissions for the UE on all the carriers and the maximum transmitting power for the UE is a maximum transmitting power for the UE on each carrier.

In some embodiments of the present application, a number of the set of carriers is larger than the maximum number of simultaneous PSFCH transmissions for the UE on all carriers, and selecting the one or more PSFCHs from the set of PSFCHs may include: selecting the one or more of PSFCHs with a number as the same as the maximum number of simultaneous PSFCH transmissions for the UE on all carriers in an descending order of highest PSFCH priority on each carrier.

In some embodiments of the present application, a transmitting power for each PSFCH on a corresponding carrier of the one or more PSFCHs is less than or equal to the maximum transmitting power for the UE on the corresponding carrier.

In some embodiments of the present application, a number of the set of carriers is smaller or equal to the maximum number of simultaneous PSFCH transmissions for the UE on all carriers, and selecting the one or more PSFCHs from the set of PSFCHs may include: for each carrier of the set of carriers, selecting a PSFCH of the set of PSFCHs with a highest priority on a corresponding carrier as a part of the one or more PSFCHs; and selecting the other part of the one or more PSFCHs from remaining PSFCHs of the set of PSFCHs in an descending order of PSFCH priority until a determined number of the one or more PSFCHs is satisfied, wherein the determined number of the one or more PSFCHs is less than or equal to the maximum number.

In some embodiments of the present application, a transmitting power for each PSFCH of the one or more PSFCHs on a corresponding carrier is the same and a total transmitting power for PSFCH(s) on the corresponding carrier is less than or equal to the maximum transmitting power for the UE on the corresponding carrier.

In some embodiments of the present application, wherein a number the set of carriers is smaller or equal to the maximum number of simultaneous PSFCH transmissions for the UE on all carriers, and selecting the one or more PSFCHs from the set of PSFCHs may include: for each carrier of the set of carriers, selecting a PSFCH of the set of PSFCHs with a highest priority on the corresponding carrier as a part of the one or more PSFCHs; and determining whether to select a PSFCH on a carrier from remaining PSFCHs of the set of PSFCHs in an descending order of PSFCH priority as the other part of the one or more PSFCHs in response to a number of currently selected PSFCHs is less than the maximum number or a number of currently selected PSFCHs plus one is less than or equal to the maximum number.

In some embodiments of the present application, determining whether to select the PSFCH on the carrier from the remaining PSFCHs of the set of PSFCHs may include: in the case that the carrier is a dedicated carrier, selecting the PSFCH on the carrier as one of the one or more PSFCHs; and in the case that the carrier is shared with a Uu interface, determining whether a transmitting power of all currently selected PSFCHs and the PSFCH on the carrier less than or equal to the maximum transmitting power on the carrier; and selecting the PSFCH on the carrier as one of the one or more PSFCHs in the case that the transmitting power is less than or equal to the maximum transmitting power on the carrier.

In some embodiments of the present application, a transmitting power for each PSFCH of the one or more PSFCHs on a dedicated carrier is the maximum transmitting power for the UE on the dedicated carrier; and a transmitting power for each PSFCH of the one or more PSFCHs on a shared carrier with a Uu interface is min(P_{CMAX,f}, P_{PSFCH,one}), wherein P_{CMAX,f} is the maximum transmitting power for performing simultaneous PSFCH transmissions on the carrier, and P_{PSFCH,one} is a transmitting power determined based on a downlink pathloss of the Uu interface.

In some embodiments of the present application, the capability of simultaneous PSFCH transmissions of the UE is a maximum number of simultaneous PSFCH transmissions for the UE on each carrier and the maximum transmitting power for the UE is a maximum transmitting power for the UE on each carrier.

In some embodiments of the present application, the configuration information indicates a set of maximum transmitting powers for the UE on all carriers, and each maximum transmitting power of the set of maximum transmitting powers is associated with at least one of a priority or a CBR range; and the method may further include: determining a maximum transmitting power from the set of maximum transmitting powers based on at least one of: a priority of a PSFCH in the set of PSFCHs or a measured CBR.

In some embodiments of the present application, the configuration information indicates a set of maximum transmitting powers for the UE on each carrier, and each maximum transmitting power of the set of maximum transmitting powers is associated with at least one of a priority or a CBR range; and the method may further include: selecting a maximum transmitting power for each carrier from the set of transmitting powers associated with the carrier based on at least one of: a priority of a PSFCH on a corresponding carrier or a measured CBR.

Embodiments of the present application provide technical solutions for PSFCH transmission, which include but are not limited to apparatuses and methods for PSFCH selection in sidelink CA operation.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates a flowchart of an exemplary method for PSFCH transmission according to some embodiments of the present application;

FIG. 3 illustrates an exemplary PSFCH selection method according to some embodiments of the present application;

FIG. 4 illustrates another exemplary PSFCH selection method according to some other embodiments of the present application;

FIG. 5 illustrates another exemplary PSFCH selection method according to some yet other embodiments of the present application;

FIG. 6 illustrates another exemplary PSFCH selection method according to some yet other embodiments of the present application;

FIG. 7 illustrates another exemplary PSFCH selection method according to some yet other embodiments of the present application;

FIG. 8 illustrates another exemplary PSFCH selection method according to some yet other embodiments of the present application; and

FIG. 9 illustrates a simplified block diagram of an exemplary apparatus for PSFCH transmission according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G new radio (NR), 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

FIG. 1 illustrates an exemplary wireless communication system 100 in accordance with some embodiments of the present application.

As shown in FIG. 1, the wireless communication system 100 includes at least one UE 101 and at least one BS 102. In particular, the wireless communication system 100 includes two UEs 101 (e.g., the UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

According to some other embodiments of the present application, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE(s) 101 may include wearable devices, such as smart watches, fitness bands, optical head-mounted displays, or the like.

According to some embodiments of the present application, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In a sidelink communication system, a transmission UE may also be named as a transmitting UE, a Tx UE, a sidelink Tx UE, a sidelink transmission UE, or the like. A reception UE may also be named as a receiving UE, an Rx UE, a sidelink Rx UE, a sidelink reception UE, or the like.

According to some embodiments of FIG. 1, UE 101a functions as a Tx UE, and UE 101b functions as an Rx UE. UE 101a may exchange sidelink messages with UE 101b through a sidelink, for example, via PC5 interface as defined in 3GPP TS 23.303. UE 101a may transmit information or data to other UE(s) within the sidelink communication system, through sidelink unicast, sidelink groupcast, or sidelink broadcast. For instance, UE 101a may transmit data to UE 101b in a sidelink unicast session. UE 101a may transmit data to UE 101b and other UE(s) in a groupcast group (not shown in FIG. 1) by a sidelink groupcast transmission session. Also, UE 101a may transmit data to UE 101b and other UE(s) (not shown in FIG. 1) by a sidelink broadcast transmission session.

Alternatively, according to some other embodiments of FIG. 1, UE 101b functions as a Tx UE and transmits sidelink messages, and UE 101a functions as an Rx UE and receives the sidelink messages from UE 101b.

Both UE 101a and UE 101b in the embodiments of FIG. 1 may transmit information to BS(s) 102 and receive control information from BS(s) 102, for example, via LTE or NR Uu interface. BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 may transmit data using an orthogonal frequency division multiplexing (OFDM) modulation scheme on the downlink (DL) and UE(s) 101 may transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 and/or UE(s) 101 may communicate using other communication protocols, such as the IEEE 802.11 family of wireless communication protocols. Further, in some embodiments of the present application, BS(s) 102 and/or UE(s) 101 may communicate over licensed spectrums, whereas in other embodiments of the present application, BS(s) 102 and/or UE(s) 101 may communicate over unlicensed spectrums. The present application is not intended to be limited to the implementation of any particular wireless communication system architecture or protocol. In yet some embodiments of the present application, BS(s) 102 may communicate with UE(s) 101 using the 3GPP 5G protocols.

In NR Rel-18, sidelink CA operation has been agreed with at least one objective including power control for simultaneous sidelink transmission (Tx). In sidelink CA operation, the PSFCHs may be configured on multiple carriers, and they may overlap in the time domain. However, due to the restrictions on UE capability of simultaneous PSFCH transmissions and maximum transmitting power, not all the configured PSFCHs can be transmitted simultaneously, and thus the UE needs to select a part of the overlapped PSFCHs for actual transmission. Herein, the wording “actual transmission” is just used for distinguishing from configured PSFCHs, which may not be transmitted due to partial or all of the above restrictions, and whether the PSFCH is successfully transmitted is not considered for the actual transmission). However, how to select the part of PSFCHs for the actual transmission has not been discussed yet.

Given the above, embodiments of the present application provide improved solutions of PSFCH transmission in sidelink CA operation, which provides some alternative schemes on PSFCH selection for actual transmission under sidelink CA scenario when the PSFCHs overlap in the time domain, thereby supporting the sidelink CA operation at least considering the backwards compatibility. More details on embodiments of the present application will be illustrated in the following text in combination with the appended drawings.

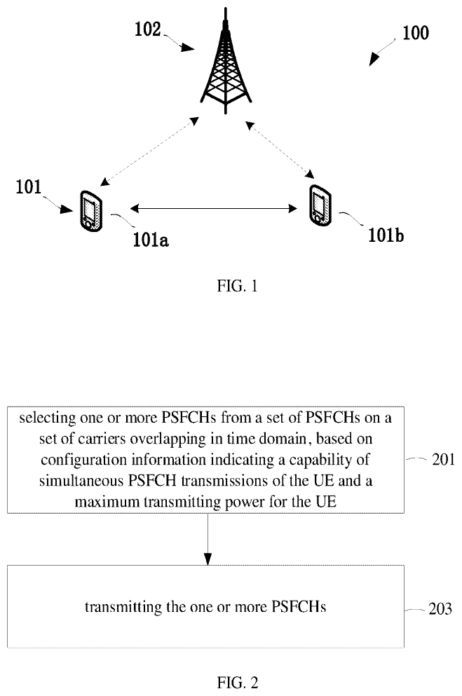

FIG. 2 illustrates a flowchart of an exemplary method for PSFCH transmission according to some embodiments of the present application. The method illustrated in FIG. 2 may be performed by a UE (e.g., the UE 101a or UE 101b in FIG. 1) or other apparatus with the like functions.

As shown in FIG. 2, in step 201, the UE may select one or more PSFCHs from a set of PSFCHs on a set of carriers based on configuration information indicating a capability of simultaneous PSFCH transmissions of the UE and a maximum transmitting power for the UE. Each carrier may be a dedication carrier or a shared carrier. Herein, a dedicated carrier may refer to a carrier not shared with a Uu interface, and a shared carrier may refer to a carrier shared with a Uu interface.

The set of PSFCHs are PSFCHs that the UE intends to (or would like to) transmit on the set of carriers, which may be configured but may not be actually transmitted, and the one or more PSFCHs are PSFCHs that the UE actually transmits.

The set of PSFCHs may include a number of PSFCHs on the set of carriers, e.g., N_{sch,TX,PSFCH}, which is an integer larger than 0. The number of PSFCHs may overlap in the time domain. The term “overlap” herein refers to partially overlap and/or fully overlap.

The set of PSFCHs may include a number of PSFCHs on each carrier of the set of carriers, e.g., N_{sch,TX,PSFCH,f}, which is an integer larger than 0, and N_{sch,TX,PSFCH}=Σ_{f=1}^{N}N_{sch,TX,PSFCH,f}, wherein f is a carrier of the set of carriers and N is the number of carriers in the set of carriers.

In some embodiments of the present application, the capability of simultaneous PSFCH transmissions of the UE and the maximum transmitting power for the UE may by indicated by single configuration information or separate configuration information. For example, the configuration information include first separate configuration information indicating the capability of simultaneous PSFCH transmissions of the UE and second separate configuration information indicating the maximum transmitting power for the UE.

In some embodiments of the present application, the configuration information indicating a capability of simultaneous PSFCH transmissions of the UE and a maximum transmitting power for the UE may be configured or pre-configured to the UE.

In an embodiment of the present application, the configuration information configured to the first UE may refer to that: the configuration information is transmitted by a BS (e.g., the BS 102 as shown in FIG. 1) to the UE via a signaling, e.g., a system information block (SIB), a master information block (MIB), a radio resource control (RRC) signaling, a medium access control (MAC) control element (CE), or DCI, and thereby the UE may receive the configuration information from the BS.

In another embodiment of the present application, the configuration information pre-configured to the UE may refer to that: the configuration information may be hard-wired into the UE or stored on a subscriber identity module (SIM) or universal subscriber identity module (USIM) card for the UE, and thereby the UE may obtain the configuration information within the UE.

Embodiments of the present application provide various PSFCH selection schemes, which will be specifically in detail in the following in view of different configuration information. After selecting the one or more PSFCHs, in step 203, the UE may transmit the selected one or more PSFCHs.

According to some embodiments of the present application, the capability of simultaneous PSFCH transmissions of the UE may be a maximum number (e.g., N_{max,PSFCH}) of simultaneous PSFCH transmissions for the UE on all carriers (i.e., the maximum number of PSFCHs that the UE is capable to transmit on all carriers) and the maximum transmitting power for the UE is a maximum transmitting power for the UE on all carriers (e.g., P_{CMAX}).

In some cases, the set of carries are all dedicated carriers, that is, the set of carriers does not include any shared carrier. Selecting the one or more PSFCHs from the set of PSFCHs may include: selecting the one or more PSFCHs from the set of PSFCHs according to a descending order of PSFCH priority, wherein the number of the one or more PSFCHs is less than or equal to the maximum number of simultaneous PSFCH transmissions for the UE on all carriers. A transmitting power for each PSFCH of the one or more PSFCHs is the same and a total transmitting power for the one or more PSFCHs is less than or equal to the maximum transmitting power for the UE on all carriers. The PSFCH priority can be represented by various manners. For example, in some embodiments of the present application, PSFCH priorities can be represented by the priority field value indicated in the SCI associated with the PSFCH transmission, a higher priority field value indicated in the SCI may indicate a lower PSFCH priority. Accordingly, a descending order of PSFCH priority may refer to an ascending order of priority field values.

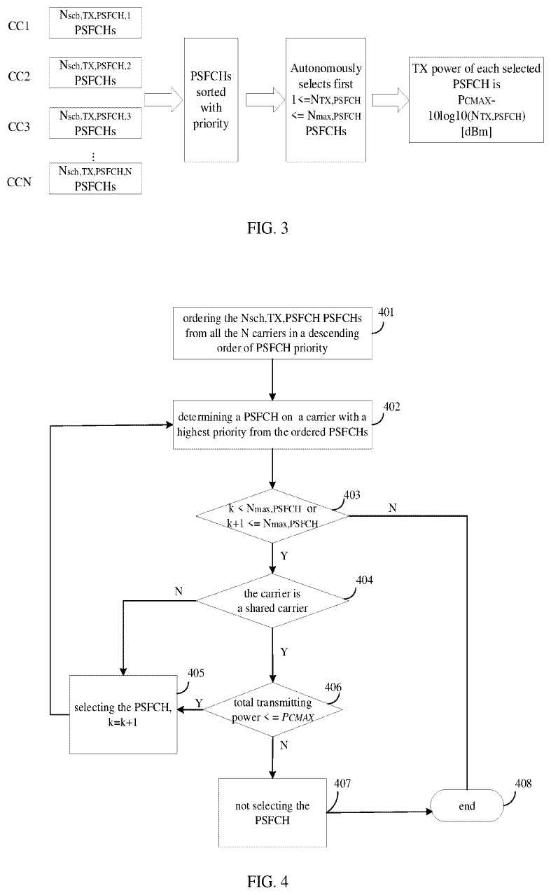

For example, FIG. 3 illustrates an exemplary PSFCH selection method according to some embodiments of the present application.

Referring to FIG. 3, it is assumed that the set of carriers includes N carriers indexed as CC1, CC2, . . . , CCN, and the set of PSFCHs may include N_{sch,TX,PSFCH,1} PSFCHs on CC1, N_{sch,TX,PSFCH,2} PSFCHs on CC2, . . . , N_{sch,TX,PSFCH,N} PSFCHs on CCN.

Moreover, it is also assumed that the maximum number of simultaneous PSFCH transmissions for the UE on all carriers is N_{max,PSFCH} and the maximum transmitting power for the UE on all carriers is P_{CMAX}.

Then, the UE may order (or sort) the PSFCHs on all the N carriers in a descending order of PSFCH priority. Then, the UE may select N_{TX,PSFCH} PSFCHs from the ordered PSFCHs (i.e., the PSFCH with a higher priority should be selected firstly), wherein 1≤N_{TX,PSFCH}≤N_{max,PSFCH}. For each PSFCH among N_{TX,PSFCH} selected PSFCHs, the transmitting power is the same and a total transmitting power for the N_{TX,PSFCH} is less than or equal to P_{CMAX}, for example, the transmitting power for each PSFCH may be P_{CMAX}−10 log₁₀(N_{TX,PSFCH}) [dBm].

For example, it is assumed that the set of PSFCHs includes 9 PSFCHs on 3 carriers, which includes PSFCHs #1-#3 on CC1, PSFCHs #4-#6 on CC2, and PSFCHs #7-#9 on CC3, and PSFCHs #1-#9 have priority #1-#9, respectively, and N_{max,PSFCH} is 6. Then, the UE may order PSFCHs #1-#9 in a descending order of PSFCH priority. Accordingly, the order PSFCHs may be PSFCHs #9, #8, . . . , #1. Then, the UE may select N_{TX,PSFCH} PSFCHs from the ordered PSFCHs, for example, N_{TX,PSFCH} is 5. Accordingly, PSFCHs #9, #8, #7, #6, and #5 may be selected as the one or more PFSCHs actually transmitted by the UE, and the transmitting power for each selected PFSCH may be P_{CMAX}−10 log₁₀(5).

In some other cases, the set of carriers include at least one shared carrier, for example, at least one carrier shared with a Uu interface.

In such cases, selecting the one or more PSFCHs from the set of PSFCHs may include: determining whether the number of currently selected PSFCHs is smaller than the maximum number of simultaneous PSFCH transmissions for the UE on all carriers, or determining whether the number of currently selected PSFCHs plus one is smaller than or equal to the maximum number of simultaneous PSFCH transmissions of the UE on all carriers. In response to that the number of currently selected PSFCHs is smaller than the maximum number of simultaneous PSFCH transmissions for the UE on all carriers or the number of currently selected PSFCHs plus one is smaller than or equal to the maximum number of simultaneous PSFCH transmissions for the UE on all carriers, selecting the one or more PSFCHs from the set of PSFCHs may further include determining whether to select a PSFCH on a carrier from the set of carriers as one of the one or more PSFCHs.

In some embodiments of the present application, the PSFCH on the carrier is determined from the set of PSFCHs according to a descending order of PSFCH priority. Determining whether to select the PSFCH on the carrier as one of the one or more PSFCHs may include:
1) in the case that the carrier is a dedicated carrier, selecting the PSFCH; or
2) in the case that the carrier is a shared carrier,
   determining whether a total transmitting power of all currently selected PSFCHs and the PSFCH is less than or equal to the maximum transmitting power of the UE on all carriers; and
   selecting the PSFCH in response to the total transmitting power is less than or equal to the maximum transmitting power for the UE on all carriers.

After selecting the one or more PSFCHs, the UE may transmit the selected one or more PSFCHs In the case that all the one or more PSFCHs are on dedicated carriers, a transmitting power for each PSFCH of the one or more PSFCHs is the same and a total transmitting power for the one or more PSFCHs are less than or equal to the maximum transmitting power for the UE on all carriers. In the case that the one or more PSFCHs include PSFCH(s) on carrier(s) shared with a Uu interface, a transmitting power for each PSFCH of the one or more PSFCHs is the same and based on a downlink pathloss of the Uu interface.

For example, FIG. 4 illustrates another exemplary PSFCH selection method according to some other embodiments of the present application.

Referring to FIG. 4, it is assumed that the set of carriers includes N carriers indexed with CC1, CC2, . . . , CCN, and the set of PSFCHs may include N_{sch,TX,PSFCH,1} PSFCHs on CC1, N_{sch,TX,PSFCH,2} PSFCHs on CC2, . . . , N_{sch,TX,PSFCH,N} PSFCHs on CCN, and the total number of the set of PSFCHs is N_{sch,TX,PSFCH}.

Moreover, it is also assumed that the maximum number of simultaneous PSFCH transmissions for the UE on all carriers is N_{max,PSFCH} and the maximum transmitting power for the UE on all carriers is P_{CMAX}.

Then, in step 401, the UE may order (i.e., sort) N_{sch,TX,PSFCH} PSFCHs in a descending order of PSFCH priority. For example, it is assumed that the ordered PSFCHs is PSFCH₁, PSFCH₂, . . . , PSFCH_{N}_{_{sch,TX,PSFCH}}, wherein PSFCH₁ has the highest priority.

In step 402, the UE may determine a PSFCH (e.g., PSFCH₁) with the highest priority from the ordered PSFCHs, wherein the determined PSFCH is on a carrier (e.g., carrier f).

In step 403, the UE may determine whether the number of currently selected PSFCHs (e.g., k, k>=0) is smaller than the N_{max,PSFCH}, or whether the number of currently selected PSFCHs plus one (e.g., k+1) is smaller than or equal to N_{max,PSFCH}. The currently selected PSFCHs may refer to PSFCHs currently selected by the UE for actual transmission before selecting the (k+1)th PSFCH. In some other embodiments of the present application, this step may be performed before determining the PSFCH or after selecting a PSFCH.

In the case that the number of currently selected PSFCHs (e.g., k) is smaller than the N_{max,PSFCH}, or the number of currently selected PSFCHs plus one (e.g., k+1) is smaller than or equal to N_{max,PSFCH}, the procedure goes to step 404; otherwise, the UE terminates the selection in step 408, that is, the selection procedure ends.

In step 404, the UE may determine whether the carrier of the determined PSFCH is a shared carrier with a Uu interface.

In the case that the carrier of the determined PSFCH is not a shared carrier (e.g., a dedicated carrier), the procedure goes to step 405. In step 405, the determined PSFCH may be selected for actual transmission, the number of currently selected PSFCHs may be incremented by 1 (e.g., k will be replaced by (k+1)). The UE may return to step 402 to determine the next PSFCH (e.g., PSFCH₂) on a carrier from the ordered PSFCHs and continue to perform steps 403-408.

In the case that the carrier of the determined PSFCH is a shared carrier (e.g., being a dedicated carrier), the procedure goes to step 406. In step 406, the UE may calculate the total transmitting power of all currently selected PSFCHs and the determined PSFCH, and determine whether the total transmitting power is less than or equal to P_{CMAX}. In step 406, in order to calculate the total transmitting power, the UE may assume that a transmitting power for each of all currently selected PSFCHs and the determined PSFCH is P_{PSFCH,one}=P_{O,PSFCH}+10 log₁₀(2^{μ})+α_{PSFCH}*PL [dBm], wherein P_{O,PSFCH} and α_{PSFCH} are parameters related to the PSFCH power control for shared carrier with Uu interface as specified in 3GPP standard documents, u is a parameter related to subcarrier spacing (SCS) as specified in 3GPP standard documents, and PL is a downlink pathloss in a Uu interface (e.g., pathloss from the BS to the UE) calculated by the UE. Given this, the total transmitting power of all currently selected PSFCHs and the determined PSFCH is equal to P_{PSFCH,one}*(k+1).

In the case that the total transmitting power is less than or equal to P_{CMAX}, the procedure goes to step 405 as stated above.

In the case that the total transmitting power is larger than P_{CMAX}, the procedure goes to step 407. In step 407, the determined PSFCH is not selected for actual transmission, and the number of currently selected PSFCHs is maintained. Then, the procedure goes to step 408. The UE terminates the selection in step 408, that is, the selection procedure ends.

Finally, the UE may select N_{TXPSFCH} PSFCHs for actual transmission. In the case that all the N_{TX,PSFCH} PSFCHs are on dedicated carriers, a transmitting power for each PSFCH of the N_{TXPSFCH} PSFCHs is the same and a total transmitting power for the N_{TX,PSFCH} PSFCHs are less than or equal to the maximum transmitting power for the UE on all carriers, for example, and the transmitting power of each PSFCH among selected PSFCHs is same and is P_{CMAX}−10 log₁₀(N_{TX,PSFCH}) [dBm].

In the case that the N_{TX,PSFCH} PSFCHs include at least one PSFCH on at least one carrier shared with a Uu interface, a transmitting power for each PSFCH of the N_{TX,PSFCH} PSFCHs is the same and based on a downlink pathloss of the Uu interface. For example, the transmitting power of each PSFCH among the selected PSFCHs is the same, e.g., P_{PSFCH,one} as stated above.

According to some other embodiments of the present application, the capability of simultaneous PSFCH transmissions of the UE may be a maximum number (e.g., N_{max,PSFCH,f}) of simultaneous PSFCH transmissions for the UE on each carrier of the set of carriers (i.e., the maximum number of PSFCHs that the UE is capable to transmit on each carrier) and the maximum transmitting power for the UE is a maximum transmitting power for the UE on all carriers (e.g., P_{CMAX}).

In some cases, the set of carries are all dedicated carriers, that is, the set of carriers does not include any shared carrier. In an embodiment of the present application, selecting the one or more PSFCHs from the set of PSFCHs may include: for each carrier, selecting at least one PSFCH from a sub-set of PSFCHs on a corresponding carrier according to an descending order of PSFCH priority, wherein the number of the at least one PSFCH is less than or equal to the maximum number of simultaneous PSFCH transmissions for the UE on the corresponding carrier. After selecting the one or more PSFCHs, in step 203, the UE may transmit the selected one or more PSFCHs according to a transmitting power. The transmitting power for each PSFCH of the one or more PSFCHs is the same and a total transmitting power for the one or more PSFCHs is less than or equal to the maximum transmitting power for simultaneous PSFCH transmissions of the UE.

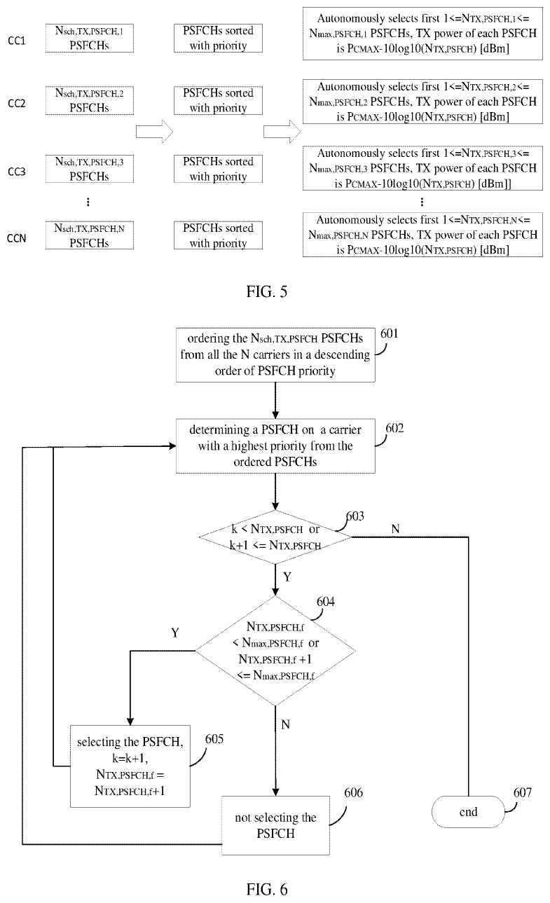

For example, FIG. 5 illustrates another exemplary PSFCH selection method according to some other embodiments of the present application.

Referring to FIG. 5, it is assumed that the set of carriers includes N carriers indexed as CC1, CC2, . . . , CCN, and the set of PSFCHs may include N_{sch,TX,PSFCH,1} PSFCHs on CC1, N_{sch,TX,PSFCH,2} PSFCHs on CC2, . . . . N_{sch,TX,PSFCH,N} PSFCHs on CCN.

Moreover, it is also assumed that the maximum numbers of simultaneous PSFCH transmissions respectively for the UE on CC1 to CCN are N_{max,PSFCH,1}, N_{max,PSFCH,2}, . . . . N_{max,PSFCH,N}, respectively, and the maximum transmitting power for the UE on all carriers is P_{CMAX}.

Then, for each carrier f of N carriers, the UE may order (or sort) the N_{sch,TX,PSFCH,f} PSFCHs on a corresponding carrier in a descending order of PSFCH priority, wherein f=1, 2, 3, . . . , N. Then, for each carrier f of the N carriers, the UE may select first N_{TX,PSFCH,f} PSFCHs from the ordered PSFCHs on the carrier f (i.e., the PSFCH with a higher priority should be selected firstly), wherein 1≤N_{TX,PSFCH,f}≤N_{max,PSFCH,f}. Accordingly, the total number of the one or more PSFCHs for actual transmission is N_{TX,PSFCH}=Σ_{f=1}^{N}N_{TX,PSFCH,f}.

For each PSFCH among the N_{TX,PSFCH} selected PSFCHs, the transmitting power is the same and the total transmitting power for the N_{TX,PSFCH} PSFCHs is less than or equal to P_{CMAX}. For example, the transmitting power for each PSFCH may be P_{CMAX}−10 log₁₀(N_{TX,PSFCH}) [dBm].

In another embodiment of the present application, selecting the one or more PSFCHs from the set of PSFCHs may include: determining whether the number of currently selected PSFCHs is smaller than the determined number of the one or more PSFCHs; or determining whether the number of currently selected PSFCHs plus one is smaller than or equal to the determined number of the one or more PSFCHs. In response to that the number of currently selected PSFCHs is smaller than the determined number of the one or more PSFCHs or the number of currently selected PSFCHs plus one is smaller than or equal to the determined number of the one or more PSFCHs, whether to select a PSFCH on a carrier as one of the one or more PSFCHs will be determined. The determined PSFCH number may be autonomously determined by the UE and may be smaller than or equal to a maximum number of simultaneous PSFCH transmissions for the UE on all the carriers, which is equal to a sum of the maximum number of simultaneous PSFCH transmissions for the UE on each carrier of the set of carrier.

In some embodiments of the present application, the PSFCH on the carrier is determined from the set of PSFCHs according to a descending order of PSFCH priority. Determining whether to select the PSFCH on the carrier as one of the one or more PSFCHs may include:
1) determining whether the number of currently selected PSFCHs on the carrier is smaller than the maximum number of simultaneous PSFCH transmissions for the UE on the carrier; or determining whether the number of currently selected PSFCHs plus one is smaller than or equal to the maximum number of simultaneous PSFCH transmissions for the UE on the carrier; and
2) selecting the PFCH on the carrier as one of the one or more PSFCHs in response to that the number of currently selected PSFCHs on the carrier is smaller than the maximum number of simultaneous PSFCH transmissions for the UE on the carriers or the number of currently selected PSFCHs on the carrier plus one is smaller than or equal to the maximum number of simultaneous PSFCH transmissions for the UE on the carrier.

After selecting the one or more PSFCHs, in step 203, the UE may transmit the selected one or more PSFCHs according to a transmitting power. The transmitting power for each PSFCH of the one or more PSFCHs is the same and the total transmitting power for the one or more PSFCHs is less than or equal to the maximum transmitting power for simultaneous PSFCH transmissions of the UE.

For example, FIG. 6 illustrates another exemplary PSFCH selection method according to some other embodiments of the present application.

Referring to FIG. 6, it is assumed that the set of carriers include N carriers indexed as CC1, CC2, . . . , CCN, and the set of PSFCHs may include N_{sch,TX,PSFCH,1} PSFCHs on CC1, N_{sch,TX,PSFCH,2} PSFCHs on CC2, . . . . N_{sch,TX,PSFCH,N} PSFCHs on CCN. The total number of the set of PSFCHs is N_{sch,TX,PSFCH}.

Moreover, it is also assumed that the maximum numbers of simultaneous PSFCH transmissions respectively for the UE on CC1 to CCN are N_{max,PSFCH,1}, N_{max,PSFCH,2}, . . . N_{max,PSFCH,N}, respectively, and the maximum transmitting power for the UE on all carriers is P_{CMAX}.

Then, in step 601, the UE may order (i.e., sort) N_{sch,TX,PSFCH} PSFCHs in a descending order of PSFCH priority. For example, it is assumed that the ordered PSFCHs is PSFCH₁, PSFCH₂, . . . , PSFCH_{N}_{_{sch,TX,PSFCH}}, wherein the PSFCH₁ has the highest priority.

In step 602, the UE may determine a PSFCH (e.g., PSFCH₁) with the highest priority from the ordered PSFCHs, wherein the determined PSFCH is on a carrier (e.g., carrier f, wherein f=1, 2, . . . , or N).

In step 603, the UE may determine whether the number of currently selected PSFCHs (e.g., k) is smaller than N_{TX,PSFCH}, or whether the number of currently selected PSFCHs plus one (e.g., k+1) is smaller than or equal to N_{TX,PSFCH}, wherein N_{TX,PSFCH} is the number of PSFCHs for actual transmission, which may be autonomously determined by the UE and may be smaller than or equal to Σ_{f=1}^{N}N_{max,PSFCH,f}, wherein Σ_{f=1}^{N}N_{max,PSFCH,f} is the maximum number of simultaneous PSFCH transmissions for the UE on all the carriers. In some other embodiments of the present application, this step may be performed before determining the PSFCH or after selecting a PSFCH.

In the case that the number of currently selected PSFCHs (e.g., k) is smaller than the N_{TX,PSFCH}, or the number of currently selected PSFCHs plus one (e.g., k+1) is smaller than or equal to N_{TX,PSFCH}, the procedure goes to step 604; otherwise, the UE terminates the selection (step 607).

In step 604, the UE may determine whether the number of currently selected PSFCHs on the carrier f (e.g., N_{TX,PSFCH,f}) is smaller than N_{max,PSFCH,f}, or determine whether the number of currently selected PSFCHs on the carrier f plus one (e.g., N_{TX,PSFCH,f}+1) is smaller than or equal to N_{max,PSFCH,f}. In the case that N_{TX,PSFCH,f} is smaller than N_{max,PSFCH,f}, or N_{TX,PSFCH,f}+1 is smaller than or equal to N_{max,PSFCH,f}, the procedure goes to step 605; otherwise, the procedure goes to 606.

In step 605, the determined PSFCH may be selected for actual transmission, the number of currently selected PSFCHs may be incremented by 1 (e.g., k=k+1), the number of currently selected PSFCHs on the carrier f may be incremented by 1 (e.g., N_{TX,PSFCH,f} is replaced by N_{TX,PSFCH,f}+1). The UE may return to step 602 to determine the next PSFCH (e.g., PSFCH₂) on a carrier from the ordered PSFCHs and continue to perform steps 603-607.

In step 606, the determined PSFCH is not selected for actual transmission, k and N_{TX,PSFCH,f} are maintained. The UE may return to step 602 to determine the next PSFCH (e.g., PSFCH₂) on a carrier from the ordered PSFCHs and continue to perform steps 603-607.

Finally, the UE may select N_{TX,PSFCH} PSFCHs for actual transmission. A transmitting power for each PSFCH of the N_{TX,PSFCH} PSFCHs is the same and a total transmitting power for the N_{TX,PSFCH} PSFCHs is less than or equal to the maximum transmitting power for the UE on all carriers. For example, the transmitting power of each PSFCH among selected PSFCHs is same and is P_{CMAX}−10 log₁₀(N_{TX,PSFCH}) [dBm].

In some other cases, the set of carriers include at least one shared carrier. In other words, the set of carriers include at least one carrier shared with a Uu interface. Selecting the one or more PSFCHs from the set of PSFCHs may include: determining whether to select a PSFCH on a carrier as one of the one or more PSFCHs. The PSFCH on the carrier may be determined from the set of PSFCHs according to an descending order of PSFCH priority, and determining whether to select a PSFCH on the carrier as one of the one or more PSFCHs may include:
1) determining whether the number of currently selected PSFCHs on the carrier is smaller than the maximum number of simultaneous PSFCH transmissions for the UE on the carrier; or determining whether the number of currently selected PSFCHs plus one is smaller than or equal to the maximum number of simultaneous PSFCH transmissions for the UE on the carrier; and
2) in response to that the number of currently selected PSFCHs on the carrier is smaller than the maximum number of simultaneous PSFCH transmissions for the UE on the carriers or the number of currently selected PSFCHs on the carrier plus one is smaller than or equal to the maximum number of simultaneous PSFCH transmissions for the UE on the carrier:
   a) in the case of the carrier being a dedicated carrier, selecting the PSFCH on the carrier; or
   b) in the case of the carrier being a shared carrier,
      i. determining whether a total transmitting power of all currently selected PSFCHs and the PSFCH on the carrier is less than or equal to the maximum transmitting power for the UE on all carriers; and
      ii. selecting the PSFCH on the carrier in response to the total transmitting power is less than or equal to the maximum transmitting power for the UE on all carriers.

After selecting the one or more PSFCHs, the UE may transmit the selected one or more PSFCHs according to a transmitting power. The transmitting power for the selected one or more PSFCHs may be determined as follows: in the case that all the one or more PSFCHs are on dedicated carriers, a transmitting power for each PSFCH of the one or more PSFCHs is the same and a total transmitting power for the one or more PSFCHs are less than or equal to the maximum transmitting power for the UE on all carriers; and in the case that the one or more PSFCHs include PSFCH(s) on carrier(s) shared with a Uu interface, a transmitting power for each PSFCH of the one or more PSFCHs is the same and based on a downlink pathloss of the Uu interface.

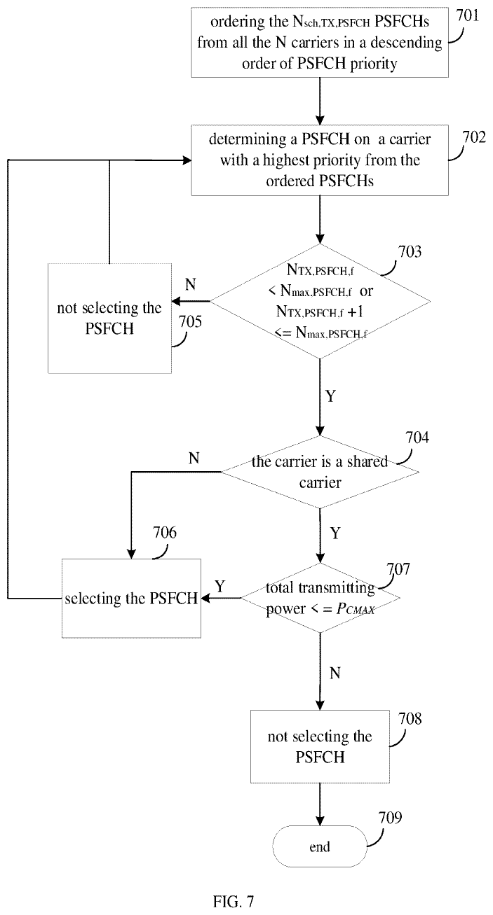

For example, FIG. 7 illustrates another exemplary PSFCH selection method according to some other embodiments of the present application.

Referring to FIG. 7, it is assumed that the set of carriers includes N carriers indexed with CC1, CC2, . . . , CCN, and the set of PSFCHs may include N_{sch,TX,PSFCH,1} PSFCHs on CC1, N_{sch,TX,PSFCH,2} PSFCHs on CC2, . . . . N_{sch,TX,PSFCH,N} PSFCHs on CCN. The total number of the set of PSFCHs is N_{sch,TX,PSFCH}.

Moreover, it is also assumed that the maximum numbers of simultaneous PSFCH transmissions respectively for the UE on CC1 to CCN are N_{max,PSFCH,1}, N_{max,PSFCH,2}, . . . N_{max,PSFCH,N}, respectively; and the maximum transmitting power for the UE on all carriers is P_{CMAX}.

Then, in step 701, the UE may order (i.e., sort) N_{sch,TX,PSFCH} PSFCHs in a descending order of PSFCH priority. For example, it is assumed that the ordered PSFCHs is PSFCH₁, PSFCH₂, . . . , PSFCH_{N}_{_{sch,TX,PSFCH}}, wherein PSFCH₁ has the highest priority.

In step 702, the UE may determine a PSFCH (e.g., PSFCH₁) with the highest priority from the ordered PSFCHs, wherein the determined PSFCH is on a carrier (e.g., carrier f, wherein f=1, 2, . . . , or N).

In step 703, the UE may determine whether the number of currently selected PSFCHs on the carrier f (e.g., N_{TX,PSFCH,f}) is smaller than N_{max,PSFCH,f}, or determine whether the number of currently selected PSFCHs on the carrier f plus one (e.g., N_{TX,PSFCH,f}+1) is smaller than or equal to N_{max,PSFCH,f}. In the case that N_{TX,PSFCH,f} is smaller than N_{max,PSFCH,f}, or N_{TX,PSFCH,f}+1 is smaller than or equal to N_{max,PSFCH,f}, the procedure goes to step 704; otherwise, the procedure goes to step 705.

In step 705, the determined PSFCH and all of the remaining PSFCHs on the carrier f are not selected for actual transmission, and the number of currently selected PSFCHs on carrier f (e.g., N_{TX,PSFCH,f}) is maintained. Then, the UE may return to step 702 to determine the next PSFCH (e.g., PSFCH₂) on another carrier different from the carrier f from the ordered PSFCHs and continue to perform steps 703-709.

In step 704, the UE may determine whether the carrier of the determined PSFCH is a shared carrier with a Uu interface.

In the case that the carrier of the determined PSFCH is not a shared carrier (e.g., is a dedicated carrier), the procedure goes to step 706. In step 706, the determined PSFCH may be selected for actual transmission, the number of currently selected PSFCHs on the carrier f may be incremented by 1 (e.g., N_{TX,PSFCH,f} is replaced by N_{TX,PSFCH,f}+1). Then, the UE may return to step 702 to determine the next PSFCH (e.g., PSFCH₂) on a carrier from the ordered PSFCHs and continue to perform steps 703-709.

In the case that the carrier of the determined PSFCH is a shared carrier (e.g., a dedicated carrier), the procedure goes to step 707. In step 707, the UE may calculate the total transmitting power of all currently selected PSFCHs and the determined PSFCH, and determine whether the total transmitting power is less than or equal to P_{CMAX}. In step 707, in order to calculate the total transmitting power, the UE may assume that a transmitting power for each of all currently selected PSFCHs and the determined PSFCH is P_{PSFCH,one} as stated above. Given this, the total transmitting power of all currently selected PSFCHs and the PSFCH is equal to P_{PSFCH,one}*(k+1), wherein k is the number of currently selected PSFCHs for actual transmission.

In the case that the total transmitting power is less than or equal to P_{CMAX}, the procedure goes to step 706 as stated above.

In the case that the total transmitting power is larger than P_{CMAX}, the procedure goes to step 708. In step 708, the determined PSFCH is not selected for actual transmission, and the number of currently selected PSFCHs is maintained. Then, the procedure goes to step 709. The UE terminates the selection in step 709, that is, the selection procedure ends.

Finally, the UE may select N_{TX,PSFCH} PSFCHs for actual transmission. In the case that all the N_{TX,PSFCH} PSFCHs are on dedicated carriers, a transmitting power for each PSFCH of the N_{TX,PSFCH} PSFCHs is the same and a total transmitting power for the N_{TX,PSFCH} PSFCHs is less than or equal to the maximum transmitting power for the UE on all carriers. For example, the transmitting power of each PSFCH among selected PSFCHs is same and is P_{CMAX}−10 log₁₀(N_{TX,PSFCH}) [dBm]. In the case that the N_{TX,PSFCH} PSFCHs include at least one PSFCH on at least one carrier shared with a Uu interface, a transmitting power for each PSFCH of the N_{TX,PSFCH} PSFCHs is the same and based on a downlink pathloss of the Uu interface. For example, the transmitting power of each PSFCH among selected PSFCHs is same and is P_{PSFCH,one} as stated above.

According to some embodiments of the present application, the capability of simultaneous PSFCH transmissions of the UE may be the maximum number (e.g., N_{max,PSFCH}) of simultaneous PSFCH transmissions for the UE on all carriers (i.e., the maximum number of PSFCHs that the UE is capable to transmit on all carriers) and the maximum transmitting power for the UE is the maximum transmitting power for the UE on each carrier of the set of carriers (e.g., P_{CMAX,f}).

In some cases, the set of carries are all dedicated carriers, that is, the set of carriers does not include any shared carrier.

In such cases, in an embodiment of the present application, the number of the set of carriers is larger than the maximum number of simultaneous PSFCH transmissions for the UE on all carriers. In such embodiment, selecting the one or more PSFCHs from the set of PSFCHs may include: selecting the one or more of PSFCHs with a number as the same as the maximum number of simultaneous PSFCH transmissions for the UE on all carriers in a descending order of highest PSFCH priority on each carrier. A transmitting power for each PSFCH on a corresponding carrier of the one or more PSFCHs is less than or equal to the maximum transmitting power for the UE on the corresponding carrier.

After selecting the one or more PSFCHs, in step 203, the UE may transmit the selected one or more PSFCHs according to the transmitting power as stated above.

For example, it is assumed that the set of carriers include N carriers indexed with CC1, CC2, . . . , CCN, and the set of PSFCHs may include N_{sch,TX,PSFCH,1} PSFCHs on CC1, N_{sch,TX,PSFCH,2} PSFCHs on CC2, . . . . N_{sch,TX,PSFCH,N} PSFCHs on CCN.

Moreover, it is also assumed that the maximum number of simultaneous PSFCH transmissions for the UE on all carriers is N_{max,PSFCH} and the maximum transmitting power for the UE on each carrier is of the N carriers is P_{CMAX,f}, wherein f is 1, 2, . . . , N.

Then, the UE may order (or sort) the PSFCH with the highest priority from each carrier of the set of carriers in a descending order of PSFCH priority. Then, the UE may select first N_{max,PSFCH} PSFCHs from the ordered PSFCHs (i.e., the PSFCH with a higher priority should be selected firstly). For each PSFCH on a carrier f among N_{max,PSFCH} selected PSFCHs, the transmitting power is the same is less than or equal to P_{CMAX,f}.

For example, it is assumed that the set of PSFCHs includes 9 PSFCHs, which includes PSFCHs #1-#3 on CC #1, PSFCHs #4-#6 on CC #2, and PSFCHs #7-#9 on CC #3, and PSFCHs #1-#9 have priority #1-#9, respectively, and N_{max,PSFCH} is 2. Then, the UE may first determine a PSFCH with a highest priority on each carrier, which are respectively PSFCH #3 on CC1, PSFCH #6 on CC2, and PSFCH #9 on CC3. Then, the UE may order the PSFCH with highest priority from each carrier in a descending order of PSFCH priority, and thus the ordered PSFCH #9, PSFCH #6, and PSFCH #3. Then, the UE may select first two PSFCHs from the ordered PSFCHs, i.e., PSFCH #9 and PSFCH #6, the transmitting power for PSFCH #9 is P_{CMAX,3} and the transmitting power for PSFCH #6 is P_{CMAX,2}.

In another embodiment of the present application, the number of the set of carriers is smaller than or equal to the maximum number of simultaneous PSFCH transmissions for the UE on all carriers. Selecting the one or more PSFCHs from the set of PSFCHs may include: for each carrier of the set of carriers, selecting a PSFCH of the set of PSFCHs with a highest priority on a corresponding carrier as a part of the one or more PSFCHs; and selecting the other part of the one or more PSFCHs from remaining PSFCHs of the set of PSFCHs in an descending order of PSFCH priority until a determined number of the one or more PSFCHs is satisfied, wherein the determined number of the one or more PSFCHs is less than or equal to the maximum number. The determined number may be autonomously determined by the UE and may be smaller than or equal to a maximum number of simultaneous PSFCH transmissions for the UE on all the carriers.

After selecting the one or more PSFCHs, the UE may transmit the selected one or more PSFCHs according to a transmitting power. The transmitting power for each PSFCH of the one or more PSFCHs on a corresponding carrier is the same and a total transmitting power for PSFCH(s) on the corresponding carrier is less than or equal to the maximum transmitting power for the UE on the corresponding carrier.

For example, it is assumed that the set of carriers includes N carriers indexed with CC1, CC2, . . . , CCN, and the set of PSFCHs may include N_{sch,TX,PSFCH,1} PSFCHs on CC1, N_{sch,TX,PSFCH,2} PSFCHs on CC2, . . . , N_{sch,TX,PSFCH,N} PSFCHs on CCN.

Moreover, it is also assumed that the maximum number of simultaneous PSFCH transmissions for the UE on all carriers is N_{max,PSFCH} and the maximum transmitting power for the UE on each carrier is of the N carriers is P_{CMAX,f}, wherein f is 1, 2, . . . , N.

Then, the UE may select the PSFCH with the highest priority on each carrier of the set of carriers for actual transmission. That is, the UE may select N PSFCHs from N carriers.

The UE may order (or sort) the remaining non-selected PSFCHs from all of the set of carriers in a descending order of PSFCH priority. Then, the UE may select the first number, e.g., M of PSFCHs from the ordered PSFCHs such that M+N is less than or equal to N_{TX,PSFCH}, wherein N_{TX,PSFCH} may be the number of PSFCHs for actual transmission, which may be autonomously determined by the UE and is less than or equal to N_{max,PSFCH}. For each PSFCH on carrier f of the N_{TX,PSFCH} PSFCHs, the transmitting power is the same and may be P_{CMAX,f}−10 log₁₀(N_{TX,PSFCH,f}) [dBm], wherein N_{TX,PSFCH,f} is the number of selected PSFCHs on the carrier f.

In some other cases, the set of carriers include at least one shared carrier. In other words, the set of carriers include at least one carrier shared with a Uu interface.

In an embodiment of the present application, the number of the set of carriers is larger than the maximum number of simultaneous PSFCH transmissions for the UE on all carriers. Selecting the one or more PSFCHs from the set of PSFCHs may include: selecting the one or more of PSFCHs with a number as the same as the maximum number of simultaneous PSFCH transmissions for the UE on all carriers in a descending order of highest PSFCH priority on each carrier.

After selecting the one or more PSFCHs, the UE may transmit the selected one or more PSFCHs according to a transmitting power. The transmitting power for each PSFCH of the one or more PSFCHs on a dedicated carrier is the maximum transmitting power for the UE on the dedicated carrier, and a transmitting power for each PSFCH of the one or more PSFCHs on a shared carrier with a Uu interface is min(P_{CMAX,f}, P_{PSFCH,one}), wherein P_{CMAX,f} is the maximum transmitting power for performing simultaneous PSFCH transmissions on the carrier, and P_{PSFCH,one} is a transmitting power determined based on a downlink pathloss of the Uu interface as stated above.

For example, it is assumed that the set of carriers include N carriers indexed with CC1, CC2, . . . . CCN, and the set of PSFCHs may include N_{sch,TX,PSFCH,1} PSFCHs on CC1, N_{sch,TX,PSFCH,2} PSFCHs on CC2, . . . . N_{sch,TX,PSFCH,N} PSFCHs on CCN.

Moreover, it is also assumed that the maximum number of simultaneous PSFCH transmissions for the UE on all carriers is N_{max,PSFCH} and the maximum transmitting power for the UE on each carrier is of the N carriers is P_{CMAX,f}, wherein f is 1, 2, . . . , N.

Then, the UE may order (or sort) the PSFCH with the highest priority from each carrier of the set of carriers in a descending order of PSFCH priority. Then, the UE may select first N_{max,PSFCH} PSFCHs from the ordered PSFCHs (i.e., the PSFCH with a higher priority should be selected firstly). For each selected PSFCH on a dedicated carrier f, the transmitting power is the same and is less than or equal to P_{CMAX,f}. For each selected PSFCH on a shared carrier f, the transmitting power is the same and is min (P_{CMAX,f}, P_{PSFCH,one}).

In another embodiment of the present application, the number of the set of carriers is smaller than or equal to the maximum number of simultaneous PSFCH transmissions for the UE on all carriers. Selecting the one or more PSFCHs from the set of PSFCHs may include: for each carrier of the set of carriers, selecting a PSFCH of the set of PSFCHs with a highest priority on the corresponding carrier as a part of the one or more PSFCHs; and determining whether to select a PSFCH on a carrier from remaining PSFCHs of the set of PSFCHs in an descending order of PSFCH priority as the other part of the one or more PSFCHs in response to the number of currently selected PSFCHs is less than the maximum number or the number of currently selected PSFCHs plus one is less than or equal to the maximum number. Determining whether to select the PSFCH on the carrier from the remaining PSFCHs of the set of PSFCHs may include:
1) in the case that the carrier is a dedicated carrier, selecting the PSFCH on the carrier as one of the one or more PSFCHs; or
2) in the case that the carrier is shared with a Uu interface,
   a) determining whether a transmitting power of all currently selected PSFCHs and the PSFCH on the carrier less than or equal to the maximum transmitting power on the carrier; and
   b) selecting the PSFCH on the carrier as one of the one or more PSFCHs in the case that the transmitting power is less than or equal to the maximum transmitting power on the carrier.

After selecting the one or more PSFCHs, the UE may transmit the selected one or more PSFCHs according to a transmitting power. The transmitting power for each PSFCH of the one or more PSFCHs on a dedicated carrier is the maximum transmitting power for the UE on the dedicated carrier, and the transmitting power for each PSFCH of the one or more PSFCHs on a shared carrier with a Uu interface is min (P_{CMAX,f}, P_{PSFCH,one}), wherein P_{CMAX,f} is the maximum transmitting power for performing simultaneous PSFCH transmissions on the carrier, and P_{PSFCH,one} is a transmitting power determined based on a downlink pathloss of the Uu interface as stated above.

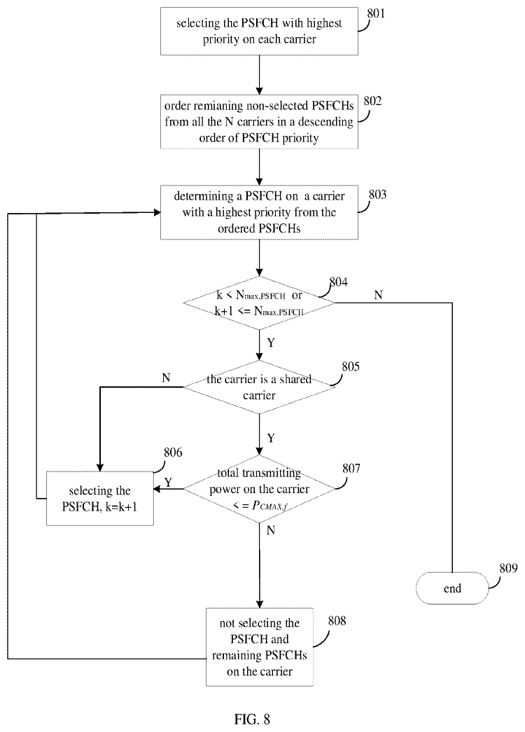

For example, FIG. 8 illustrates another exemplary PSFCH selection method according to some other embodiments of the present application.

Referring to FIG. 8, it is assumed that the set of carriers includes N carriers indexed with CC1, CC2, . . . , CCN, and the set of PSFCHs may include N_{sch,TX,PSFCH,1} PSFCHs on CC1, N_{sch,TX,PSFCH,2} PSFCHs on CC2, . . . . N_{sch,TX,PSFCH,N} PSFCHs on CCN, and the total number of the set of PSFCHs is N_{sch,TX,PSFCH}.

Moreover, it is also assumed that the maximum number of simultaneous PSFCH transmissions for the UE on all carriers is N_{max,PSFCH} and the maximum transmitting power for the UE on each carrier of the set of carriers is P_{CMAX,f}.

Then, in step 801, the UE may select the PSFCH with highest priority on each carrier of the set of carriers for actual transmission. That is, the UE may select N PSFCHs from N carriers.

In step 802, the UE may order (or sort) the remaining non-selected PSFCHs from all of the set of carriers in a descending order of PSFCH priority.

In step 803, the UE may determine a PSFCH with the highest priority from the ordered PSFCHs, wherein the determined PSFCH is on a carrier (e.g., carrier f).

In step 804, the UE may determine whether the number of currently selected PSFCHs (e.g., k) is smaller than the N_{max,PSFCH}, or whether the number of currently selected PSFCHs plus one (e.g., k+1) is smaller than or equal to N_{max,PSFCH}. In step 804, the currently selected PSFCHs may refer to PSFCHs currently selected by the UE for actual transmission.

In the case that the number of currently selected PSFCHs (e.g., k) is smaller than the N_{max,PSFCH}, or the number of currently selected PSFCHs plus one (e.g., k+1) is smaller than or equal to N_{max,PSFCH}, the procedure goes to step 805; otherwise, the UE terminates the selection (step 809).

In step 805, the UE may determine whether the carrier of the determined PSFCH is a shared carrier with a Uu interface.

In the case that the carrier of the determined PSFCH is not a shared carrier (e.g., is a dedicated carrier), the procedure goes to step 806. In step 806, the determined PSFCH may be selected for actual transmission, the number of currently selected PSFCHs may be incremented by 1 (e.g., k=k+1). Then, the UE may return to step 803 to determine the next PSFCH (e.g., PSFCH₂) on a carrier from the ordered PSFCHs and continue to perform step 804-809.

In the case that the carrier of the determined PSFCH is a shared carrier (e.g., is a dedicated carrier), the procedure goes to step 807. In step 807, the UE may calculate the total transmitting power of all currently selected PSFCHs on the carrier f and the PSFCH on the carrier f, and determine whether the total transmitting power on the carrier f is less than or equal to P_{CMAX}. In step 807, in order to calculate the total transmitting power, the UE may assume that a transmitting power for each of all currently selected PSFCHs on the carrier f and the PSFCH on the carrier f is P_{PSFCH,one} as stared above.

In the case that the total transmitting power is less than or equal to P_{CMAX,f}, the procedure goes to step 806 as stated above.

In the case that the total transmitting power is larger than P_{CMAX,f}, the procedure goes to step 808. In step 808, the determined PSFCH and the remaining PSFCHs on the carrier are not selected for actual transmission, and the number of currently selected PSFCHs is maintained. Then, the UE may return to step 803 to determine the next PSFCH on a carrier different from the carrier f from the ordered PSFCHs and continue to perform steps 804-809.

Finally, for each carrier f, the UE may select N_{TX,PSFCH,f} PSFCHs for actual transmission. In the case that the carrier f is a dedicated carrier, a transmitting power for each PSFCH of the N_{TX,PSFCH,f} PSFCHs is the same and a total transmitting power for the N_{TX,PSFCH} PSFCHs is less than or equal to the maximum transmitting power for the UE on all carriers. For example, the transmitting power of each PSFCH among selected PSFCHs on the carrier f is same and is P_{CMAX}−10 log₁₀(N_{TX,PSFCH,f}) [dBm]. In the case that the carrier f is shared with Uu interface, UE transmits N_{TX,PSFCH,f} PSFCHs on carrier f, the transmitting power of each PSFCH among selected PSFCHs on the carrier f is same and is min (P_{CMAX,f}, P_{PSFCH,one}).

According to some other embodiments, the capability of simultaneous PSFCH transmissions of the UE may be the maximum number of simultaneous PSFCH transmissions for the UE on each carrier of the set of carriers and the maximum transmitting power for the UE may be the maximum transmitting power for the UE on each carrier of the set of carriers. For each carrier of the set of carriers, the UE may reuse the procedure as specified in section 16.2.3 of TS 38.213 to select one or more PSFCHs on a corresponding carrier for actual transmission and determine a transmitting power for each selected PSFCH. The difference is that during such a procedure, the maximum transmitting power (e.g., P_{CMAX}) in section 16.2.3 of TS 38.213 may be replaced with the configured or pre-configured maximum transmitting power on a corresponding carrier (e.g., P_{CMAX,f}), and the maximum number of simultaneous PSFCH transmissions (e.g., N_{max,PSFCH}) in section 16.2.3 of TS 38.213 may be replaced with the configured or pre-configured maximum number of simultaneous PSFCH transmissions on a corresponding carrier (e.g., N_{max,PSFCH,f}).

In the above embodiments of FIG. 2, the configuration information may indicate a single value of the maximum transmitting power for the UE on all carriers (e.g., P_{CMAX}) or indicate a single value of the maximum transmitting power for the UE on each carrier (e.g., P_{CMAX,f}) of the set of carriers.

However, in some other embodiments of FIG. 2, the configuration information may indicate a set of maximum transmitting powers for the UE on all carriers, and each maximum transmitting power of the set of maximum transmitting powers is associated with at least one of a priority or a CBR range. Then, after receiving the configuration information, the UE may select a maximum transmitting power from the set of maximum transmitting powers based on at least one of: a priority of a PSFCH in the set of PSFCHs or a measured CBR. For example, the priority used to select the maximum transmitting power may be the highest priority among all the set of PSFCHs on all of the set of carriers. After selecting the maximum transmitting power, the UE may use the selected maximum transmitting power to perform the procedures in above embodiments.

In some other embodiments of the present application, the configuration information may indicate a set of maximum transmitting powers for the UE on each carrier, and each maximum transmitting power of the set of maximum transmitting powers is associated with at least one of a priority or a CBR range. After receiving the configuration information, the UE may select the maximum transmitting power for each carrier from the set of transmitting powers associated with the carrier based on at least one of: a priority of a PSFCH on a corresponding carrier or a measured CBR. For example, the priority used to select the maximum transmitting power for each carrier may be the highest priority among all the set of PSFCHs on a corresponding carrier. After selecting the maximum transmitting power, the UE may use the selected maximum transmitting power to perform the procedures in above embodiments.

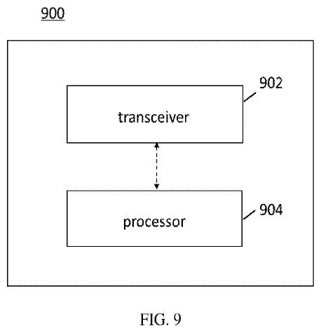

FIG. 9 illustrates a simplified block diagram of an exemplary apparatus 900 for PSFCH transmission according to some embodiments of the present application. In some embodiments, the apparatus 900 may be or include at least part of a UE (e.g., the UE 101a or UE 101b in FIG. 1).

Referring to FIG. 9, the apparatus 900 may include at least one processor 904 and at least one transceiver 902 coupled to the processor 904.

Although in this figure, elements such as the at least one transceiver 902 and processor 904 are described in the singular, the plural is contemplated unless a limitation to the singular is explicitly stated. In some embodiments of the present application, the transceiver 902 may be divided into two devices, such as a receiving circuitry and a transmitting circuitry. In some embodiments of the present application, the apparatus 900 may further include an input device, a memory, and/or other components.

According to some embodiments of the present application, the apparatus 900 may be a UE. The processor 904 may be configured to select one or more PSFCHs from a set of PSFCHs on a set of carriers overlapping in time domain, based on configuration information indicating a capability of simultaneous PSFCH transmissions of the UE and a maximum transmitting power for the UE. The transceiver 902 may be configured to transmit the one or more PSFCHs.

In some embodiments of the present application, the apparatus 900 may further include at least one non-transitory computer-readable medium. In some embodiments of the present disclosure, the non-transitory computer-readable medium may have stored thereon computer-executable instructions to cause a processor to implement the method with respect to a UE as described above. For example, the computer-executable instructions, when executed, cause the processor 904 to interact with the transceiver (or transmitter and/or the receiver), so as to perform operations of the methods, e.g., as described in view of FIGS. 2-8.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for packet duplication, including a processor and a memory. Computer programmable instructions for implementing a method for packet duplication are stored in the memory, and the processor is configured to perform the computer programmable instructions to implement the method for packet duplication. The method for packet duplication may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for packet duplication according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE) for wireless communication, comprising:
at least one memory; and
at least one processor coupled with the at least one memory and configured to cause the UE to:
select one or more physical sidelink feedback channels (PSFCHs) from a set of PSFCHs on a set of carriers overlapping in time domain, based on configuration information indicating a capability of simultaneous PSFCH transmissions of the UE and a maximum transmitting power for the UE; and
transmit the one or more PSFCHs.

2. The UE of claim 1, wherein the capability of simultaneous PSFCH transmissions of the UE is a maximum number of simultaneous PSFCH transmissions for the UE on all carriers of the set of carriers and the maximum transmitting power for the UE is a maximum transmitting power for the UE on all carriers of the set of carriers.

3. The UE of claim 2, wherein to select the one or more PSFCHs from the set of PSFCHs, the at least one processor is further configured to cause the UE to:
select the one or more PSFCHs from the set of PSFCHs according to a descending order of PSFCH priority, wherein a number of the one or more PSFCHs is less than or equal to the maximum number of simultaneous PSFCH transmissions for the UE on all carriers.

4. The UE of claim 2, wherein to select the one or more PSFCHs from the set of PSFCHs, the at least one processor is further configured to cause the UE to:
determine whether a number of currently selected PSFCHs is smaller than the maximum number of simultaneous PSFCH transmissions for the UE on all carriers of the set of carriers, or determine whether the number of currently selected PSFCHs plus one is smaller than or equal to the maximum number of simultaneous PSFCH transmissions of the UE on all carriers of the set of carriers; and
determine whether to select a PSFCH on a carrier of the set of carriers as one of the one or more PSFCHs in response to the number of currently selected PSFCHs being smaller than the maximum number of simultaneous PSFCH transmissions for the UE on all carriers of the set of carriers or the number of currently selected PSFCHs plus one being smaller than or equal to the maximum number of simultaneous PSFCH transmissions for the UE on all carriers of the set of carriers.

5. The UE of claim 4, wherein the PSFCH on the carrier is determined from the set of PSFCHs according to a descending order of PSFCH priority, and to determine whether to select the PSFCH on the carrier as one of the one or more PSFCHs, the at least one processor is further configured to cause the UE to:
in a case that the carrier is a dedicated carrier, select the PSFCH;
in a case that the carrier is a shared carrier,
determine whether a total transmitting power of all currently selected PSFCHs and the PSFCH is less than or equal to the maximum transmitting power of the UE on all carriers of the set of carriers; and
select the PSFCH in response to the total transmitting power being less than or equal to the maximum transmitting power for the UE on all carriers of the set of carriers.

6. The UE of claim 1, wherein the capability of simultaneous PSFCH transmissions of the UE is a maximum number of simultaneous PSFCH transmissions for the UE on each carrier of the set of carriers and the maximum transmitting power of the UE is a maximum transmitting power for the UE on all carriers of the set of carriers.

7. The UE of claim 6, wherein to select selecting the one or more PSFCHs from the set of PSFCHs, the at least one processor is further configured to cause the UE to:
for each carrier of the set of carriers, select at least one PSFCH from a sub-set of PSFCHs on a corresponding carrier according to a descending order of PSFCH priority, wherein a number of the at least one PSFCH is less than or equal to the maximum number of simultaneous PSFCH transmissions for the UE on the corresponding carrier.

8. The UE of claim 6, wherein to select the one or more PSFCHs from the set of PSFCHs, the at least one processor is further configured to cause the UE to:
determine whether a number of currently selected PSFCHs is smaller than a determined number of the one or more PSFCHs, or determine whether the number of currently selected PSFCHs plus one is smaller than or equal to the determined number of the one or more PSFCHs; and
determine whether to select a PSFCH on a carrier of the set of carriers as one of the one or more PSFCHs in response to the number of currently selected PSFCHs being smaller than the determined number of the one or more PSFCHs or the number of currently selected PSFCHs plus one being smaller than or equal to the determined number of the one or more PSFCHs.

9. The UE of claim 8, wherein the PSFCH on the carrier is determined from the set of PSFCHs according to a descending order of PSFCH priority, and to determine whether to select the PSFCH on the carrier as one of the one or more PSFCHs, the at least one processor is further configured to cause the UE to:
determine whether a number of currently selected PSFCHs on the carrier is smaller than the maximum number of simultaneous PSFCH transmissions for the UE on the carrier, or determine whether a number of currently selected PSFCHs plus one is smaller than or equal to the maximum number of simultaneous PSFCH transmissions for the UE on the carrier; and
select the PSFCH on the carrier as one of the one or more PSFCHs in response to that the number of currently selected PSFCHs on the carrier being smaller than the maximum number of simultaneous PSFCH transmissions for the UE on the carriers or the number of currently selected PSFCHs on the carrier plus one being smaller than or equal to the maximum number of simultaneous PSFCH transmissions for the UE on the carrier.

10. The UE of claim 6, wherein to select the one or more PSFCHs from the set of PSFCHs, the at least one processor is further configured to cause the UE to:
determine whether to select a PSFCH on a carrier of the set of carriers as one of the one or more PSFCHs, wherein the PSFCH on the carrier is determined from the set of PSFCHs according to a descending order of PSFCH priority, and to determine whether to select a PSFCH on the carrier as one of the one or more PSFCHs comprises:
determine whether a number of currently selected PSFCHs on the carrier is smaller than the maximum number of simultaneous PSFCH transmissions for the UE on the carrier, or determine whether a number of currently selected PSFCHs plus one is smaller than or equal to the maximum number of simultaneous PSFCH transmissions for the UE on the carrier; and
in response to that the number of currently selected PSFCHs on the carrier being smaller than the maximum number of simultaneous PSFCH transmissions for the UE on the carriers or the number of currently selected PSFCHs on the carrier plus one being smaller than or equal to the maximum number of simultaneous PSFCH transmissions for the UE on the carrier:
in a case of the carrier being a dedicated carrier, select the PSFCH on the carrier;
in a case of the carrier being a shared carrier,
determine whether a total transmitting power of all currently selected PSFCHs and the PSFCH on the carrier is less than or equal to the maximum transmitting power for the UE on all carriers of the set of carriers; and
select the PSFCH on the carrier in response to the total transmitting power being less than or equal to the maximum transmitting power for the UE on all carriers of the set of carriers.

11. The UE of claim 1, wherein the capability of simultaneous PSFCH transmissions of the UE is a maximum number of simultaneous PSFCH transmissions for the UE on all the carriers of the set of carriers and the maximum transmitting power for the UE is a maximum transmitting power for the UE on each carrier of the set of carriers.

12. The UE of claim 11, wherein a number of the set of carriers is larger than the maximum number of simultaneous PSFCH transmissions for the UE on all carriers of the set of carriers, and to select the one or more PSFCHs from the set of PSFCHs, the at least one processor is further configured to cause the UE to:
select the one or more PSFCHs to have a same number as the maximum number of simultaneous PSFCH transmissions for the UE on all carriers in a descending order of highest PSFCH priority on each carrier.

13. The UE of claim 11, wherein a number of the set of carriers is smaller or equal to the maximum number of simultaneous PSFCH transmissions for the UE on all carriers of the set of carriers, and to select the one or more PSFCHs from the set of PSFCHs, the at least one processor is further configured to cause the UE to:
for each carrier of the set of carriers, select a PSFCH of the set of PSFCHs with a highest priority on a corresponding carrier as a part of the one or more PSFCHs; and
select another part of the one or more PSFCHs from remaining PSFCHs of the set of PSFCHs in a descending order of PSFCH priority until a determined number of the one or more PSFCHs is satisfied, wherein the determined number of the one or more PSFCHs is less than or equal to the maximum number.

14. The UE of claim 1, wherein the capability of simultaneous PSFCH transmissions of the UE is a maximum number of simultaneous PSFCH transmissions for the UE on each carrier and the maximum transmitting power for the UE is a maximum transmitting power for the UE on each carrier.

15. A method performed by a user equipment (UE), the method comprising:
selecting one or more physical sidelink feedback channels (PSFCHs) from a set of PSFCHs overlapping in time domain on a set of carriers, based on configuration information indicating a capability of simultaneous PSFCH transmissions and a maximum transmitting power for simultaneous PSFCH transmissions; and
transmitting the one or more PSFCHs.

16. The method of claim 15, wherein the capability of simultaneous PSFCH transmissions of the UE is a maximum number of simultaneous PSFCH transmissions for the UE on all carriers of the set of carriers and the maximum transmitting power for the UE is a maximum transmitting power for the UE on all carriers of the set of carriers.

17. The method of claim 16, wherein selecting the one or more PSFCHs from the set of PSFCHs comprises:
selecting the one or more PSFCHs from the set of PSFCHs according to a descending order of PSFCH priority, wherein a number of the one or more PSFCHs is less than or equal to the maximum number of simultaneous PSFCH transmissions for the UE on all carriers.

18. A processor for wireless communication, comprising:
at least one controller coupled with at least one memory and configured to cause the processor to:
select one or more physical sidelink feedback channels (PSFCHs) from a set of PSFCHs on a set of carriers overlapping in time domain, based on configuration information indicating a capability of simultaneous PSFCH transmissions of the processor and a maximum transmitting power for the processor; and
transmit the one or more PSFCHs.

19. The processor of claim 18, wherein the capability of simultaneous PSFCH transmissions of the processor is a maximum number of simultaneous PSFCH transmissions for the processor on all carriers of the set of carriers and the maximum transmitting power for the processor is a maximum transmitting power for the processor on all carriers of the set of carriers.

20. The processor of claim 19, wherein to select the one or more PSFCHs from the set of PSFCHs, the at least one controller is further configured to cause the processor to:
select the one or more PSFCHs from the set of PSFCHs according to a descending order of PSFCH priority, wherein a number of the one or more PSFCHs is less than or equal to the maximum number of simultaneous PSFCH transmissions for the processor on all carriers.
